(19) United States
(12) Patent Application Publication
(10) Pub. No.: US 2015/0225567 A1
(43) Pub. Date: Aug. 13, 2015

(54) Toughened Polyarylene Sulfide Composition

(71) Applicant: Ticona LLC, Florence, KY (US)

(72) Inventors: Kent R. Miller, Cincinnati, OH (US); Xiaoyan Tu, Fremont, CA (US); Rong Luo, Florence, KY (US); Xinyu Zhao, Cincinnati, OH (US)

(21) Appl. No.: 14/526,563

(22) Filed: Oct. 29, 2014

Related U.S. Application Data
(60) Provisional application No. 61/938,214, filed on Feb. 11, 2014.

(51) Int. Cl. C08L 81/04

(52) U.S. Cl. CPC C08L 81/04; C08L 2205/025; C08L 2205/035

(57) ABSTRACT

A polymer composition that comprises a polyarylene sulfide, inorganic fibers, impact modifier, and a functionalized coupling system is provided. The functionalized coupling system includes a disulfide compound and an organosilane compound. The weight ratio of organosilane compounds to disulfide compounds is from about 0.1 to about 10.

### RELATED APPLICATIONS

The present application claims priority to U.S. Provisional Application Ser. No. 61/938,214, filed on Feb. 11, 2014, which is incorporated herein in its entirety by reference thereto.

### BACKGROUND OF THE INVENTION

Polymeric materials are employed in a wide variety of different devices. As the demand for thinner devices has increased, so has the demand for higher performance plastic materials that can be molded into the desired configurations. One such material is polyphenylene sulfide (“PPS”), which is a high performance polymer that can withstand high thermal, chemical, and mechanical stresses. PPS is generally formed via polymerization of p-dichlorobenzene with an alkali metal sulfide or an alkali metal hydrosulfide, forming polymers that include chlorine at the terminal groups. In an effort to improve impact strength, impact modifiers (e.g., elastomeric polymers) are often blended with PPS compositions. Unfortunately, most impact modifiers are incompatible with PPS, which can lead to phase separation of the components over time and a corresponding reduction in mechanical performance. As such, a need currently exists for a polyarylene sulfide composition that is capable of exhibiting good impact strength without sacrificing other properties.

### SUMMARY OF THE INVENTION

In accordance with one embodiment of the present invention, a polymer composition is disclosed that comprises a polyarylene sulfide, inorganic fibers, impact modifier, and a functionalized coupling system. The functionalized coupling system includes a disulfide compound and an organosilane compound. The weight ratio of organosilane compounds to disulfide compounds is from about 0.1 to about 10.

Other features and aspects of the present invention are set forth in greater detail below.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition that includes a polyarylene sulfide, impact modifier, and inorganic fibers (e.g., glass fibers). The composition also contains a functionalized coupling system that includes a combination of a disulfide compound and an organosilane compound. Without intending to be limited by theory, it is believed that the functionalized coupling system can accomplish multiple functions, all of which can significantly improve the compatibilization of the impact modifier and inorganic fibers with the polyarylene sulfide. For instance, the organosilane compound may undergo a reaction with the inorganic fibers and/or impact modifier, thereby allowing for reactive coupling of such components to the polyarylene sulfide. Meanwhile, the disulfide may undergo a chain scission reaction with the polyarylene sulfide to lower its melt viscosity, which can lead to decreased attrition of the inorganic fibers and thus improved compatibility between the components.

The relative amount of the disulfide and organosilane compounds employed in the functionalized coupling system, as well as the total amount of the system in the polymer composition, may be selectively controlled to help achieve the desired balance between various properties. More particularly; the weight ratio of organosilane compounds to disulfide compounds in the system generally ranges from about 0.1 to about 10, in some embodiments from about 0.3 to about 8, in some embodiments from about 0.5 to about 5, and in some embodiments, from about 1 to about 4. Organosilane compounds, for instance, may constitute from about 0.02 wt. % to about 4 wt. %, in some embodiments from about 0.05 wt. % to about 2 wt. %, and in some embodiments, from about 0.1 wt. % to about 0.8 wt. % of the polymer composition. Disulfide compounds may likewise constitute from about 0.01 wt. % to about 3 wt. %, in some embodiments from about 0.02 wt. % to about 1 wt. %, and in some embodiments, from about 0.05 wt. % to about 0.5 wt. % of the polymer composition. The entire functionalized coupling system also typically constitutes from about 0.05 wt. % to about 5 wt. %, in some embodiments from about 0.1 wt. % to about 4 wt. %, and in some embodiments, from about 0.2 wt. % to about 1 wt. % of the polymer composition.

Various embodiments of the present invention will now be described in greater detail below.

### I. Polymer Composition

A. Polyarylene Sulfide

Polyarylene sulfides typically constitute from about 25 wt. % to about 95 wt. %, in some embodiments from about 30 wt. % to about 80 wt. %, and in some embodiments, from about 40 wt. % to about 70 wt. % of the polymer composition. The polyarylene sulfide(s) employed in the composition generally have repeating units of the formula:

—[(Ar¹)ₙ—X]ₘ—[(Ar²)ᵢ—Y]ⱼ-[(Ar³)ₖ—Z]ₗ—[(Ar⁴)ₒ—W]ₚ—

wherein,

Ar¹, Ar², Ar³, and Ar⁴ are independently arylene units of 6 to 18 carbon atoms;

W, X, Y, and Z are independently bivalent linking groups selected from —SO₂—, —S—, —SO—, —CO—, —O—, —C(O)O— or alkylene or alkylidene groups of 1 to 6 carbon atoms, wherein at least one of the linking groups is —S—; and

n, m, i, j, k, l, o, and p are independently 0, 1, 2, 3, or 4, subject to the proviso that their sum total is not less than 2.

The arylene units Ar¹, Ar², Ar³, and Ar⁴ may be selectively substituted or unsubstituted. Advantageous arylene units are phenylene, biphenylene, naphthylene, anthracene and phenanthrene. The polyarylene sulfide typically includes more than about 30 mol %, more than about 50 mol %, or more than about 70 mol % arylene sulfide (—S—) units. For example, the polyarylene sulfide may include at least 85 mol % sulfide linkages attached directly to two aromatic rings. In one particular embodiment, the polyarylene sulfide is a polyphenylene sulfide, defined herein as containing the phenylene sulfide structure —(C₆H₄—S)ₙ— (wherein n is an integer of 1 or more) as a component thereof.

Synthesis techniques that may be used in making a polyarylene sulfide are generally known in the art. By way of example, a process for producing a polyarylene sulfide can include reacting a material that provides a hydrosulfide ion (e.g., an alkali metal sulfide) with a dihaloaromatic compound in an organic amide solvent. The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene; 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone. The halogen atom can be fluorine, chlorine, bromine or iodine, and two halogen atoms in the same dihalo-aromatic compound may be the same or different from each other. In one embodiment, o-dichlorobenzene, m-dichlorobenzene, p-dichlorobenzene or a mixture of two or more compounds thereof is used as the dihalo-aromatic compound. As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide(s) may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

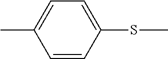

and segments having the structure of formula:

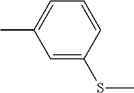

or segments having the structure of formula:

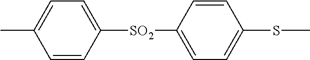

The polyarylene sulfide(s) may be linear, semi-linear, branched or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

B. Impact Modifier

Impact modifiers typically constitute from about 1 wt. % to about 40 wt. %, in some embodiments from about 2 wt. % to about 30 wt. %, and in some embodiments, from about 3 wt. % to about 25 wt. % of the polymer composition. Examples of suitable impact modifiers may include, for instance, polyepoxides, polyurethanes, polybutadiene, acrylonitrile-butadiene-styrene, polysiloxanes, polyamides, block copolymers (e.g., polyether-polyamide block copolymers), etc., as well as mixtures thereof.

In one particular embodiment, the impact modifier may include a polyepoxide that contains at least two oxirane rings per molecule. The polyepoxide may be a linear or branched, homopolymer or copolymer (e.g., random, graft, block, etc.) containing terminal epoxy groups, skeletal oxirane units, and/or pendent epoxy groups. The monomers employed to form such polyepoxides may vary. In one particular embodiment, for example, the polyepoxide modifier contains at least one epoxy-functional (meth)acrylic monomeric component. The term “(meth)acrylic” includes acrylic and methacrylic monomers, as well as salts or esters thereof, such as acrylate and methacrylate monomers. Suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate.

If desired, additional monomers may also be employed in the polyepoxide to help achieve the desired melt viscosity. Such monomers may vary and include, for example, ester monomers, (meth)acrylic monomers, olefin monomers, amide monomers, etc. In one particular embodiment, for example, the polyepoxide modifier includes at least one linear or branched α-olefin monomer, such as those having from 2 to 20 carbon atoms and preferably from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are ethylene and propylene. In one particularly desirable embodiment of the present invention, the polyepoxide modifier is a copolymer formed from an epoxy-functional (meth)acrylic monomeric component and α-olefin monomeric component. For example, the polyepoxide modifier may be poly(ethylene-co-glycidyl methacrylate). One specific example of a suitable polyepoxide modifier that may be used in the present invention is commercially available from Arkema under the name Lotader® AX8840. Lotader® AX8950 has a melt flow rate of 5 g/10 min and has a glycidyl methacrylate monomer content of 8 wt. %.

In yet another embodiment, the impact modifier may include a block copolymer in which at least one phase is made of a material that is hard at room temperature but fluid upon heating and another phase is a softer material that is rubber-like at room temperature. For instance, the block copolymer may have an A-B or A-B-A block copolymer repeating structure, where A represents hard segments and B is a soft segment. Non-limiting examples of impact modifiers having an A-B repeating structure include polyamide/polyether, polysulfone/polydimethylsiloxane, polyurethane/polyester, polyurethane/polyether, polyester/polyether, polycarbonate/polydimethylsiloxane, and polycarbonate/polyether. Triblock copolymers may likewise contain polystyrene as the hard segment and either polybutadiene, polyisoprene, or polyethylene-co-butylene as the soft segment. Similarly, styrene butadiene repeating co-polymers may be employed, as well as polystyrene/polyisoprene repeating polymers. In one particular embodiment, the block copolymer may have alternating blocks of polyamide and polyether. Such materials are commercially available, for example from Atofina under the Pebax™ trade name. The polyamide blocks may be derived from a copolymer of a diacid component and a diamine component, or may be prepared by homopolymerization of a cyclic lactam. The polyether block may be derived from homo- or copolymers of cyclic ethers such as ethylene oxide, propylene oxide, and tetrahydrofuran.

C. Inorganic Fibers

Inorganic fibers may likewise constitute from about 20 wt. % to about 70 wt. %, in some embodiments from about 25 wt. % to about 65 wt. %, and in some embodiments, from about 30 wt. % to about 60 wt. % of the polymer composition. Any of a variety of different types of inorganic fibers may generally be employed, such as those that are derived from glass; silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Glass fibers are particularly suitable for use in the present invention, such as those formed from E-glass, A-glass, C-glass, D-glass, AR-glass, R-glass, S1-glass, S2-glass, etc., as well as mixtures thereof. If desired, the glass fibers may be provided with a sizing agent or other coating as is known in the art.

The inorganic fibers may have any desired cross-sectional shape, such as circular, flat, etc. In certain embodiments, it may be desirable to employ fibers having a relatively flat cross-sectional dimension in that they have an aspect ratio (i.e., cross-sectional width divided by cross-sectional thickness) of from about 1.5 to about 10, in some embodiments from about 2 to about 8, and in some embodiments, from about 3 to about 5. Namely, the present inventors have discovered that when such flat fibers are employed in a certain concentration, they can significantly improve the mechanical properties of the molded part without having a substantial adverse impact on the melt viscosity of the polymer composition. When employed, for instance, the inorganic fibers may constitute from about 30 wt. % to about 70 wt. %, in some embodiments from about 35 wt. % to about 65 wt. %, and in some embodiments, from about 40 wt. % to about 60 wt. % of the polymer composition. The inorganic fibers may, for example, have a nominal width of from about 1 to about 50 micrometers, in some embodiments from about 5 to about 50 micrometers, and in some embodiments, from about 10 to about 35 micrometers. The fibers may also have a nominal thickness of from about 0.5 to about 30 micrometers, in some embodiments from about 1 to about 20 micrometers, and in some embodiments, from about 3 to about 15 micrometers. Further, the inorganic fibers may have a narrow size distribution. That is, at least about 60% by volume of the fibers, in some embodiments at least about 70% by volume of the fibers, and in some embodiments, at least about 80% by volume of the fibers may have a width and/or thickness within the ranges noted above. In the molded part, the volume average length of the glass fibers may be from about 10 to about 500 micrometers, in some embodiments from about 100 to about 400 micrometers, and in some embodiments, from about 150 to about 350 micrometers.

D. Functionalized Coupling System

i. Disulfide Compound

As indicated above, a disulfide compound is employed that may undergo a chain scission reaction with the polyarylene sulfide during melt processing to lower its overall melt viscosity. Disulfide compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

R³—S—S—R⁴

wherein R³ and R⁴ may be the same or different and are hydrocarbon groups that independently include from 1 to about 20 carbons, For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at terminal end(s) of the disulfide compound. For example, at least one of R³ and R⁴ may include a terminal carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid (or 2,2′-dithiobenzoic acid), dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2-dithiobis(benzoxazole), 2-(4′-morpholinodithio)benzothiazole, etc., as well as mixtures thereof.

ii Organosilane Compound

The polymer composition of the present invention also contains an organosilane compound. Such organosilane compounds typically constitute from about 0.01 wt. % to about 3 wt. %, in some embodiments from about 0.02 wt. % to about 1 wt. %, and in some embodiments, from about 0.05 to about 0.5 wt. % of the polymer composition.

The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵—Si—(R⁶)₃,

wherein,

R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;

R⁶ is an alkoxy group of from 1 to 10 carbon atoms, such as methoxy, ethoxy, propoxy, and so forth.

Some representative examples of organosilane compounds that may be included in the mixture include mercaptopropyl trimethyoxysilane, mercaptopropyl triethoxysilane, aminopropyl triethoxysilane, aminoethyl triethoxysilane, aminopropyl trimethoxysilane, aminoethyl trimethoxysilane, ethylene trimethoxysilane, ethylene triethoxysilane, ethyne trimethoxysilane, ethyne triethoxysilane, aminoethylaminopropyltrimethoxysilane, 3-aminopropyl triethoxysilane, 3-aminopropyl trimethoxysilane, 3-aminopropyl methyl dimethoxysilane or 3-aminopropyl methyl diethoxysilane, N-(2-aminoethyl)-3-aminopropyl trimethoxysilane, N-methyl-3-aminopropyl trimethoxysilane, N-phenyl-3-aminopropyl trimethoxysilane, bis(3-aminopropyl) tetramethoxysilane, bis(3-aminopropyl) tetraethoxy disiloxane, γ-aminopropyltrimethoxysilane, γ-aminopropyltriethoxysilane, γ-aminopropylmethyldimethoxysilane, γ-aminopropylmethyldiethoxysilane, N-(β-aminoethyl)-γ-aminopropyltrimethoxysilane, N-phenyl-γ-aminopropyltrimethoxysilane, γ-diallylaminopropyltrimethoxysilane, γ-diallylaminopropyltrimethoxysilane, etc., as well as combinations thereof. Particularly suitable organosilane compounds are 3-aminopropyltriethoxysilane and 3-mercaptopropyltrimethoxysilane.

E. Other Components

In addition to a polyarylene sulfide, impact modifier, inorganic fibers, and functionalized coupling system, the polymer composition may also contain a variety of other different components to help improve its overall properties. Particulate fillers may also be employed in the polymer composition. When employed, particulate fillers typically constitute from about 5 wt. % to about 60 wt. %, in some embodiments from about 10 wt. % to about 50 wt. %, and in some embodiments, from about 15 wt. % to about 45 wt. % of the polymer composition. Various types of particulate fillers may be employed as is known in the art. Clay minerals, for instance, may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K,H₃O)(Al,Mg,Fe)₂ (Si,Al)₄O₁₀[(OH)₂,(H₂O)]), montmorillonite (Na,Ca)_{0.33}(Al,Mg)₂Si₄O₁₀(OH)₂.nH₂O), vermiculite ((MgFe,Al)₃(Al,Si)₄O₁₀(OH)₂.4H₂O), palygorskite ((Mg,Al)₂Si₄O₁₀(OH).4(H₂O)), pyrophyllite (Al₂Si₄O₁₀(OH)₂), etc., as well as combinations thereof. In lieu of, or in addition to, clay minerals, still other mineral fillers may also be employed. For example, other suitable silicate fillers may also be employed, such as calcium silicate, aluminum silicate, mica, diatomaceous earth, wollastonite, and so forth. Mica, for instance, may be a particularly suitable mineral for use in the present invention. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂-3(AlSi₃)O₁₀(OH)₂), glauconite (K,Na)(Al,Mg,Fe)₂(Si,Al)₄O₁₀(OH)₂), etc., as well as combinations thereof.

If desired, a nucleating agent may also be employed to further enhance the crystallization properties of the composition. One example of such a nucleating agent is an inorganic crystalline compound, such as boron-containing compounds (e.g., boron nitride, sodium tetraborate, potassium tetraborate, calcium tetraborate, etc.), alkaline earth metal carbonates (e.g., calcium magnesium carbonate), oxides (e.g., titanium oxide, aluminum oxide, magnesium oxide, zinc oxide, antimony trioxide, etc.), silicates (e.g., talc, sodium-aluminum silicate, calcium silicate, magnesium silicate, etc.), salts of alkaline earth metals (e.g., calcium carbonate, calcium sulfate, etc.), and so forth. Boron nitride (BN) has been found to be particularly beneficial when employed in the polymer composition of the present invention. Boron nitride exists in a variety of different crystalline forms (e.g., h-BN—hexagonal, c-BN—cubic or spharlerite, and w-BN—wurtzite), any of which can generally be employed in the present invention. The hexagonal crystalline form is particularly suitable due to its stability and softness.

Lubricants may also be employed in the polymer composition that are capable of withstanding the processing conditions of poly(arylene sulfide) (typically from about 290° C. to about 320° C.) without substantial decomposition. Exemplary of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % of the polymer composition.

If desired, other polymers may also be employed in the polymer composition for use in combination with the polyarylene sulfide. When employed, such additional polymers typically constitute from about 0.1 wt. % to about 30 wt. %, in some embodiments from about 0.5 wt. % to about 20 wt. %, and in some embodiments, from about 1 wt. % to about 10 wt. % of the polymer composition. Any of a variety of polymers may be employed, such as polyimides, polyamides, polyetherimides, polyarylene ether ketones, polyesters, etc. In one particular embodiment, a liquid crystalline polymer may be employed. The term “liquid crystalline polymer” generally refers to a polymer that can possess a rod-like structure that allows it to exhibit liquid crystalline behavior in its molten state (e.g., thermotropic nematic state). The polymer may contain aromatic units (e.g., aromatic polyesters, aromatic polyesteramides, etc.) so that it is wholly aromatic (e.g., containing only aromatic units) or partially aromatic (e.g., containing aromatic units and other units, such as cycloaliphatic units). Liquid crystalline polymers are generally classified as “thermotropic” to the extent that they can possess a rod-like structure and exhibit a crystalline behavior in their molten state (e.g., thermotropic nematic state). Because thermotropic liquid crystalline polymers form an ordered phase in the melt state, they can have a relatively low shear viscosity and thus sometimes act as a flow aid for the polyarylene sulfide. The liquid crystalline polymer may also help in further improving certain mechanical properties of the polymer composition.

The liquid crystalline polymers may be formed from one or more types of repeating units as is known in the art. The liquid crystalline polymers may, for example, contain one or more aromatic ester repeating units, typically in an amount of from about 60 mol. % to about 99.9 mol. %, in some embodiments from about 70 mol. % to about 99.5 mol. %, and in some embodiments, from about 80 mol. % to about 99 mol. % of the polymer. Examples of aromatic ester repeating units that are suitable for use in the present invention may include, for instance, aromatic dicarboxylic repeating units, aromatic hydroxycarboxylic repeating units, as well as various combinations thereof.

Aromatic dicarboxylic repeating units, for instance, may be employed that are derived from aromatic dicarboxylic acids, such as terephthalic acid, phthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 0.5 mol. % to about 50 mol. %, in some embodiments from about 1 mol. % to about 30 mol. %, and in some embodiments, from about 5 mol. % to about 20% of the polymer.

Aromatic hydroxycarboxylic repeating units may also be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute from about 20 mol. % to about 85 mol. %, in some embodiments from about 40 mol. % to about 80 mol. %, and in some embodiments, from about 50 mol. % to about 75% of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, 4,4′-dihydroxybiphenyl sulfone, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 35 mol. %, in some embodiments from about 2 mol. % to about 30 mol. %, and in some embodiments, from about 5 mol. % to about 25% of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, 4,4′-diamino biphenyl sulfone, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10% of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

Still other components that can be included in the composition may include, for instance, antimicrobials, pigments (e.g., black pigments), antioxidants, stabilizers, surfactants, waxes, flow promoters, solid solvents, flame retardants, and other materials added to enhance properties and processability.

II. Melt Processing

The manner in which the polyarylene sulfide, disulfide compound, organosilane compound, impact modifier, and other optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 50° C. to about 500° C., and in some embodiments, from about 100° C. to about 250° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved impact and tensile properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

Regardless of the manner in which they are combined together, the present inventors have discovered that the polymer composition may possess a relatively low melt viscosity, which allows it to readily flow into a mold cavity during production of the part. For instance, the composition may have a melt viscosity of about 8,000 poise or less, in some embodiments about 7,000 poise or less, in some embodiments from about 1,000 to about 6,000 poise, in some embodiments from about 2,500 to about 5,500, and in some embodiments, from about 3,000 to about 5,000 poise, as determined by a capillary rheometer at a temperature of about 310° C. and shear rate of 1200 seconds⁻¹. Among other things, these viscosity properties can allow the composition to be readily molded into parts having a small dimension.

Due to the relatively low melt viscosity that can be achieved in the present invention, relatively high molecular weight polyarylene sulfides can also be fed to the extruder with little difficulty. For example, such high molecular weight polyarylene sulfides may have a number average molecular weight of about 14,000 grams per mole (“g/mol”) or more, in some embodiments about 15,000 g/mol or more, and in some embodiments, from about 16,000 g/mol to about 60,000 g/mol, as well as weight average molecular weight of about 35,000 g/mol or more, in some embodiments about 50,000 g/mol or more, and in some embodiments, from about 60,000 g/mol to about 90,000 g/mol, as determined using gel permeation chromatography as described below. One benefit of using such high molecular weight polymers is that they generally have a low chlorine content. In this regard, the resulting polymer composition may have a low chlorine content, such as about 1200 ppm or less, in some embodiments about 900 ppm or less, in some embodiments from 0 to about 800 ppm, and in some embodiments, from about 1 to about 500 ppm.

In addition, the crystallization temperature (prior to molding) of the polymer composition may about 250° C. or less, in some embodiments from about 100° C. to about 245° C., and in some embodiments, from about 150° C. to about 240° C. The melting temperature of the polymer composition may also range from about 250° C. to about 320° C., and in some embodiments, from about 260° C. to about 300° C. The melting and crystallization temperatures may be determined as is well known in the art using differential scanning calorimetry in accordance with ISO Test No. 11357. Even at such melting temperatures, the ratio of the deflection temperature under load (“DTUL”), a measure of short term heat resistance, to the melting temperature may still remain relatively high. For example, the ratio may range from about 0.65 to about 1.00, in some embodiments from about 0.70 to about 0.99, and in some embodiments, from about 0.80 to about 0.98. The specific DTUL values may, for instance, range from about 200° C. to about 300° C., in some embodiments from about 230° C. to about 290° C., and in some embodiments, from about 250° C. to about 280° C. Such high DTUL values can, among other things, allow the use of high speed processes often employed during the manufacture of components having a small dimensional tolerance.

The resulting molded part has also been found to possess excellent mechanical properties. For example, the present inventors have discovered that the impact strength of the part can be significantly improved by the use of the functionalized coupling system of the present invention, which is useful when forming small parts. The part may, for instance, possess a Charpy notched impact strength of about 5 kJ/m² or more, in some embodiments from about 8 to about 40 kJ/m², and in some embodiments, from about 10 to about 30 kJ/m², measured at 23° C. according to ISO Test No. 179-1) (technically equivalent to ASTM D256, Method B). Despite having a low melt viscosity and high impact strength, the present inventors have also discovered that the tensile and flexural mechanical properties are not adversely impacted. For example, the molded part may exhibit a tensile strength of from about 20 to about 500 MPa, in some embodiments from about 50 to about 400 MPa, and in some embodiments, from about 100 to about 350 MPa; a tensile break strain of about 0.5% or more, in some embodiments from about 0.6% to about 10%, and in some embodiments, from about 0.8% to about 3.5%; and/or a tensile modulus of from about 3,000 MPa to about 30,000 MPa, in some embodiments from about 4,000 MPa to about 25,000 MPa, and in some embodiments, from about 5,000 MPa to about 22,000 MPa. The tensile properties may be determined in accordance with ISO Test No. 527 (technically equivalent to ASTM D638) at 23° C. The part may also exhibit a flexural strength of from about 20 to about 500 MPa, in some embodiments from about 50 to about 400 MPa, and in some embodiments, from about 100 to about 350 MPa; a flexural break strain of about 0.5% or more, in some embodiments from about 0.6% to about 10%, and in some embodiments, from about 0.8% to about 3.5%; and/or a flexural modulus of from about 3,000 MPa to about 30,000 MPa, in some embodiments from about 4,000 MPa to about 25,000 MPa, and in some embodiments, from about 5,000 MPa to about 22,000 MPa. The flexural properties may be determined in accordance with ISO Test No. 178 (technically equivalent to ASTM D790) at 23° C. The molded part may also exhibit a relatively low degree of warpage, which may be quantified by the flatness value test as described herein. More particularly, the flatness value of the part may be about 0.6 millimeters or less, in some embodiments about 0.4 millimeters or less, and in some embodiments, from about 0.01 to about 0.2 millimeters.

III. Molding

The polymer composition may be molded into a part for use in a wide variety of devices. Various molding techniques may be employed, such as injection molding, compression molding, nanomolding, overmolding, etc. For example, as is known in the art, injection molding can occur in two main phases—i.e., an injection phase and holding phase. During the injection phase, the mold cavity is completely filled with the molten polymer composition. The holding phase is initiated after completion of the injection phase in which the holding pressure is controlled to pack additional material into the cavity and compensate for volumetric shrinkage that occurs during cooling. After the shot has built, it can then be cooled. Once cooling is complete, the molding cycle is completed when the mold opens and the part is ejected, such as with the assistance of ejector pins within the mold.

Regardless of the molding technique employed, it has been discovered that the polymer composition of the present invention, which may possess the unique combination of high flowability, low chlorine content, and good mechanical properties, is particularly well suited for thin molded parts. For example, the part may have a thickness of about 100 millimeters or less, in some embodiments about 50 millimeters or less, in some embodiments from about 100 micrometers to about 10 millimeters, and in some embodiments, from about 200 micrometers to about 1 millimeter. If desired, the polymer may also be integrated with or laminated to a metal component to form a composite structure. This may be accomplished using a variety of techniques, such as by nanomolding the polymer composition onto a portion or the entire surface of the metal component so that it forms a resinous component that is adhered thereto. The metal component may contain any of a variety of different metals, such as aluminum, stainless steel, magnesium, nickel, chromium, copper, titanium, and alloys thereof. Due to its unique properties, the polymer composition can adhere to the metal component by flowing within and/or around surface indentations or pores of the metal component. To improve adhesion, the metal component may optionally be pretreated to increase the degree of surface indentations and surface area. This may be accomplished using mechanical techniques (e.g., sandblasting, grinding, flaring, punching, molding, etc.) and/or chemical techniques (e.g., etching, anodic oxidation, etc.). For instance, techniques for anodically oxidizing a metal surface are described in more detail in U.S. Pat. No. 7,989,079 to Lee, et al. In addition to pretreating the surface, the metal component may also be preheated at a temperature close to, but below the melt temperature of the polymer composition. This may be accomplished using a variety of techniques, such as contact heating, radiant gas heating, infrared heating, convection or forced convection air heating, induction heating, microwave heating or combinations thereof. In any event, the polymer composition is generally injected into a mold that contains the optionally preheated metal component. Once formed into the desired shape, the composite structure is allowed to cool so that the resinous component becomes firmly adhered to the metal component.

As noted, various devices may employ a molded part formed in accordance with the present invention. One such device is a portable electronic device, which may contain a frame or housing that includes a molded part formed according to the present invention. Examples of portable electronic devices that may employ such a molded part in or as its housing include, for instance, cellular telephones, portable computers (e.g., laptop computers, netbook computers, tablet computers, etc.), wrist-watch devices, headphone and earpiece devices, media players with wireless communications capabilities, handheld computers (also sometimes called personal digital assistants), remote controllers, global positioning system (GPS) devices, handheld gaming devices, camera modules, integrated circuits (e.g., SIM cards), etc. Wireless portable electronic devices are particularly suitable. Examples of such devices may include a laptop computer or small portable computer of the type that is sometimes referred to as “ultraportables.” In one suitable arrangement, the portable electronic device may be a handheld electronic device. The device may also be a hybrid device that combines the functionality of multiple conventional devices. Examples of hybrid devices include a cellular telephone that includes media player functionality, a gaming device that includes a wireless communications capability, a cellular telephone that includes game and email functions, and a handheld device that receives email, supports mobile telephone calls, has music player functionality and supports web browsing.

It should also be understood that the polymer composition and/or molded part of the present invention may be used in a wide variety of other types of devices. For example, the polymer composition may be used in components such as bearings, electrical sensors, coils (e.g., pencil, ignition, etc.), clamps (e.g., hose clamps), valves, capacitors, switches, electrical connectors, printer parts, pumps (e.g., gear pumps, pump impellers, pump housings, etc.), dashboards, pipes, hoses, etc. The polymer composition may also be used to form fibers, fibrous webs, tapes, films, and other types of extruded articles if so desired.

The present invention may be better understood with reference to the following examples.

### Test Methods

Molecular Weight: The samples may be analyzed using a Polymer Labs GPC-220 size exclusion chromatograph. The instrument may be controlled by Precision Detector software installed on a Dell computer system. The analysis of the light scattering data may be performed using the Precision Detector software and the conventional GPC analysis was done using Polymer Labs Cirrus software. The GPC-220 may contain three Polymer Labs PLgel 10 μm MIXED-B columns running chloronaphthalene as the solvent at a flow rate of 1 ml/min at 220° C. The GPC may contain three detectors: Precision Detector PD2040 (static light scattering); Viscotek 220 Differential Viscometer; and a Polymer Labs refractometer. For analysis of the molecular weight and molecular weight distribution using the RI signal, the instrument may be calibrated using a set of polystyrene standards and plotting a calibration curve.

Melt Viscosity: The melt viscosity may be determined as scanning shear rate viscosity and determined in accordance with ISO Test No. 11443 (technically equivalent to ASTM D3835) at a shear rate of 1200 s⁻¹ and at a temperature of about 316° C. using a Dynisco 7001 capillary rheometer. The rheometer orifice (die) may have a diameter of 1 mm, a length of 20 mm, an LID ratio of 20.1, and an entrance angle of 180°. The diameter of the barrel may be 9.55 mm+0.005 mm and the length of the rod was 233.4 mm.

Tensile Modulus, Tensile Stress, and Tensile Elongation: Tensile properties may be tested according to ISO Test No. 527 (technically equivalent to ASTM D638). Modulus and strength measurements may be made on the same test strip sample having a length of 80 mm, thickness of 10 mm, and width of 4 mm. The testing temperature may be 23° C. and the testing speed may be 5 mm/min.

Flexural Modulus, Flexural Stress, and Flexural Strain: Flexural properties may be tested according to ISO Test No. 178 (technically equivalent to ASTM D790). This test may be performed on a 64 mm support span. Tests may be run on the center portions of uncut ISO 3167 multi-purpose bars. The testing temperature may be 23° C. and the testing speed may be 2 mm/min.

Izod Notched Impact Strength: Notched Izod properties may be tested according to ISO Test No. 180 (technically equivalent to ASTM D256, Method A). This test may be run using a Type A notch. Specimens may be cut from the center of a multi-purpose bar using a single tooth milling machine. The testing temperature may be 23° C.

Notched Charpy Impact Strength: Notched Charpy properties are tested according to ISO Test No. ISO 179-1) (technically equivalent to ASTM D256, Method B). This test is run using a Type A notch (0.25 mm base radius) and Type 1 specimen size (length of 80 mm, width of 10 mm, and thickness of 4 mm). Specimens are cut from the center of a multi-purpose bar using a single tooth milling machine. The testing temperature is 23° C.

Deflection Under Load Temperature (“DTUL”): The deflection under load temperature may be determined in accordance with ISO Test No. 75-2 (technically equivalent to ASTM D648-07). A test strip sample having a length of 80 mm, thickness of 10 mm, and width of 4 mm may be subjected to an edgewise three-point bending test in which the specified load (maximum outer fibers stress) is 1.8 MPa. The specimen may be lowered into a silicone oil bath where the temperature may be raised at 2° C. per minute until it deflects 0.25 mm (0.32 mm for ISO Test No. 75-2).

Chlorine Content: Chlorine content may be determined according to an elemental analysis analysis using Parr Bomb combustion followed by Ion Chromatography.

### EXAMPLE 1

The components listed in Table 1 below are mixed in a Werner Pfleiderer ZSK 25 co-rotating intermeshing twin-screw extruder with a 25 mm diameter.

TABLE 1

| Sample No. | 1 | 2 | 3 | 4 | 5 | 6 |
|---|---|---|---|---|---|---|
| Glycolube ® P | 0.3% | 0.3% | 0.3% | 0.3% | 0.3% | 0.3% |
| 910A-10C Glass Fibers | 30.0% | 30.0% | 30.0% | 30.0% | 30.0% | 30.0% |
| (Owens Corning) | | | | | | |
| 2,2′-Dithiobenzoic acid | — | — | — | 0.3% | 0.3% | 0.3% |
| (“DTBA”) | | | | | | |
| 3-Mercaptopropyl | — | — | — | 0.1% | 0.1% | 0.1% |
| trimethoxysilane | | | | | | |
| Aminosilane | 0.4% | 0.4% | 0.4% | — | — | — |
| Lotader ® AX 8840 | — | 5.0% | 10.0% | — | 5.5% | 9.0% |
| Forton ® 0214 | — | — | — | 69.3% | 63.8% | 60.3% |
| Fortron ® 0205 | 69.3% | 64.3% | 59.3% | — | — | — |

The pellets are also injection, molded on a Mannesmann Demag D100 NCIII injection molding machine and tested for certain physical characteristics, as provided in Table 2 below.

TABLE 2

| Sample No. | 1 | 2 | 3 | 4 | 5 | 6 |
|---|---|---|---|---|---|---|
| Tensile Modulus (MPa) | 11,570 | 10,088 | 9,266 | 11,483 | 10,390 | 8,859 |
| Tensile stress (MPa) | 173.4 | 159.9 | 139.0 | 151.3 | 157.6 | 138.2 |
| Tensile elongation (%) | 2.0 | 2.2 | 2.5 | 1.7 | 2.3 | 2.7 |
| Charpy Notched Impact | 7.4 | 10.5 | 11.8 | 5.9 | 11.3 | 13.3 |
| Strength (kJ/m²) | | | | | | |

### EXAMPLE 2

The components listed in Table 3 below are mixed in a Werner Pfleiderer ZSK 25 co-rotating intermeshing twin-screw extruder with a 25 mm diameter.

TABLE 3

| Sample No. | 7 | 8 | 9 | 10 | 11 | 12 |
|---|---|---|---|---|---|---|
| Glycolube ® P | 0.3% | 0.3% | 0.3% | 0.3% | 0.3% | 0.3% |
| 910A-10C Glass Fibers | 40.0% | 40.0% | 40.0% | 35.0% | 40.0% | 40.0% |
| (Owens Corning) | | | | | | |
| 2,2′-Dithiobenzoic acid | — | — | — | 0.2% | 0.2% | 0.2% |
| (“DTBA”) | | | | | | |
| 3-Mercaptopropyl | — | — | — | 0.3% | 0.3% | 0.3% |
| trimethoxysilane | | | | | | |
| Aminosilane | 0.4% | 0.4% | 0.4% | — | — | — |
| Lotader ® AX 8840 | — | 2.5% | 5.0% | 10.0% | 10.0% | 15.0% |
| Forton ® 0214 | — | — | — | 51.7% | 46.7% | 41.7% |
| Fortron ® 0205 | 59.3% | 56.8% | 54.3% | — | — | — |

The pellets are also injection molded on a Mannesmann Demag D100 NCIII injection molding machine and tested for certain physical characteristics, as provided in Table 4 below.

TABLE 4

| Sample No. | 7 | 8 | 9 | 10 | 11 | 12 |
|---|---|---|---|---|---|---|
| Tensile Modulus (MPa) | 15,866 | 14,912 | 13,890 | 10,427 | 11,663 | 10,840 |
| Tensile stress (MPa) | 208.4 | 186.4 | 171.0 | 137.6 | 143.7 | 129.3 |
| Tensile elongation (%) | 1.8 | 1.8 | 1.7 | 2.3 | 2.1 | 2.6 |
| Charpy Notched Impact | 10.2 | 10.2 | 10.5 | 11.0 | 11.4 | 15.3 |
| Strength (kJ/m²) | | | | | | |

### EXAMPLE 3

The components listed in Table 5 below are mixed in a Werner Pfleiderer ZSK 25 co-rotating intermeshing twin-screw extruder with a 25 mm diameter.

TABLE 5

| Sample No. | 13 | 14 | 15 | 16 |
|---|---|---|---|---|
| 910A-10C Glass Fibers | 20.0% | 20.0% | 20.0% | 20.6% |
| (Owens Corning) | | | | |
| 2,2′-Dithiobenzoic acid | 0.1% | 0.1% | 0.1% | 0.1% |
| (“DTBA”) | | | | |
| 3-Mercaptopropyl | 0.3% | 0.3% | 0.3% | 0.3% |
| trimethoxysilane | | | | |
| Mica | 30.6% | 30.0% | 30.0% | 30.0% |
| Lotader ® AX 8840 | 5.0% | 10.0% | 15.0% | 20.0% |
| Fortron ® 0205 | 44.6% | 39.6% | 34.6% | 29.6% |

The pellets are also injection molded on a Mannesmann Demag D100 NCIII injection molding machine and tested for certain physical characteristics, as provided in Table 6 below.

TABLE 6

| Sample No. | 13 | 14 | 15 | 16 |
|---|---|---|---|---|
| Tensile Modulus (MPa) | 13,942 | 11,556 | 9,928 | 8,213 |
| Tensile stress (MPa) | 126.9 | 102.8 | 98.7 | 82.5 |
| Tensile elongation (%) | 1.6 | 1.5 | 2.2 | 2.9 |
| Charpy Notched Impact | 4.2 | 5.4 | 7.5 | 10.5 |
| Strength (kJ/m²) | | | | |

### EXAMPLE 4

The components listed in Table 7 below are melt extruded at 310° C. in a WLE-25 co-rotating intermeshing twin-screw extruder with a 25 mm diameter.

TABLE 7

| Sample No. | 17 | 18 | 19 | 20 |
|---|---|---|---|---|
| Glycolube ® P | 0.3% | 6.0% | 0.3% | 0.3% |
| 910A-10C Glass Fibers | 30.0% | 30.0% | 30.0% | 30.0% |
| (Owens Corning) | | | | |
| 2,2′-Dithiobenzoic acid | — | 0.2% | — | 0.2% |
| (“DTBA”) | | | | |
| 3-Mercaptopropyl | — | — | 0.3% | 0.3% |
| trimethoxysilane | | | | |
| Lotader ® AX 8840 | 6.0% | 6.0% | 6.0% | 6.0% |
| Forton ® 0214 | 63.7% | 63.5% | 63.4% | 63.2% |

The pellets are also injection molded on a Mannesmann Demag D100 NCIII injection molding machine and tested for certain physical characteristics, as provided in Table 8 below.

TABLE 8

| Sample No. | 17 | 18 | 19 | 20 |
|---|---|---|---|---|
| Melt Viscosity (poise) | 4,819 | 3,288 | 4,901 | 3,096 |
| Tensile Modulus (MPa) | 9,564 | 9,741 | 9,877 | 9,744 |
| Tensile stress (MPa) | 136.4 | 140.4 | 145.1 | 145.4 |
| Tensile elongation (%) | 2.2 | 2.3 | 2.3 | 2.6 |
| Charpy Notched Impact | 10.8 | 10.1 | 11.0 | 10.5 |
| Strength (kJ/m²) | | | | |

### EXAMPLE 5

The components listed in Table 9 below are mixed in a Werner Pfleiderer ZSK 25 co-rotating intermeshing twin-screw extruder with a 25 mm diameter.

TABLE 9

| Sample No. | 21 |
|---|---|
| 910A-10C Glass Fibers | 45.0% |
| (Owens Corning) | |
| 2,2′-Dithiobenzoic acid | 0.2% |
| (“DTBA”) | |
| 3-Mercaptopropyl | 0.3% |
| trimethoxysilane | |
| PEBAX ® | 5.0% |
| Fortron ® 0205 | 20.0% |
| Fortron ® 0214 | 24.2% |
| Fortron ® 1100 | 5.0% |

The viscosity of Sample 21 was 1,230 poise.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A polymer composition comprising a polyarylene sulfide, inorganic fibers, impact modifier, and a functionalized coupling system, wherein the functionalized coupling system includes a disulfide compound and an organosilane compound, wherein the weight ratio of organosilane compounds to disulfide compounds is from about 0.1 to about 10.

2. The polymer composition of claim 1, wherein organosilane compounds constitute from about 0.02 wt. % to about 4 wt. % of the polymer composition.

3. The polymer composition of claim 1, wherein disulfide compounds constitute from about 0.01 wt. % to about 3 wt. % of the polymer composition.

4. The polymer composition of claim 1, wherein inorganic fibers constitute from about 20 wt. % to about 70 wt. % of the polymer composition, impact modifiers constitutes from about 1 wt. % to about 40 wt. % of the polymer composition, and/or polyarylene sulfides constitute from about 25 wt. % to about 95 wt. % of the polymer composition.

5. The polymer composition of claim 1, wherein the polyarylene sulfide is a linear polyphenylene sulfide.

6. The polymer composition of claim 1, wherein the disulfide compound is diphenyl sulfide, diaminodiphenyl disulfide, 3,3′-diaminodiphenyl disulfide, 4,4-diaminodiphenyl disulfide, dibenzyl disulfide, 2,2′-dithiobenzoic acid, dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′-morpholinodithio)benzothiazole, or a combination thereof.

7. The polymer composition of claim 1, wherein the organosilane compound has the following general formula:
R⁵—Si—(R⁶)₃,
wherein,
R⁵ is a sulfide group, an alkyl sulfide containing from 1 to 10 carbon atoms, alkenyl sulfide containing from 2 to 10 carbon atoms, alkynyl sulfide containing from 2 to 10 carbon atoms, amino group, aminoalkyl containing from 1 to 10 carbon atoms, aminoalkenyl containing from 2 to 10 carbon atoms, aminoalkynyl containing from 2 to 10 carbon atoms, or a combination thereof; and
R⁶ is an alkoxy group of from 1 to 10 carbon atoms.

8. The polymer composition of claim 1, wherein the organosilane compound includes 3-aminopropyltriethoxysilane, 3-mercaptopropyltrimethoxysilane, or a combination thereof.

9. The polymer composition of claim 1, wherein the impact modifier includes a polyepoxide, block copolymer, or a combination thereof.

10. The polymer composition of claim 1, further comprising a liquid crystalline polymer.

11. The polymer composition of claim 1, wherein the inorganic fibers include glass fibers.

12. The polymer composition of claim 1, wherein the inorganic fibers have an aspect ratio of from about 1.5 to about 10, wherein the aspect ratio is defined as the cross-sectional width of the fibers divided by the cross-sectional thickness of the fibers.

13. The polymer composition of claim 1, wherein the composition has a melt viscosity of about 8,000 poise or less as determined in accordance with ISO Test NO. 11443 at a shear rate of 1200s⁻¹ and at a temperature of 316° C.

14. The polymer composition of claim 1, wherein the polymer composition has a chlorine content of about 1200 parts per million or less.

15. A molded part comprising the polymer composition of claim 1.

16. The molded part of claim 15, wherein the part has a notched Charpy impact strength of about 5 kJ/m² or more, measured at a temperature of 23° C. according to ISO Test No. 179-1.

17. The molded part of claim 15, wherein the part has a thickness of about 100 millimeters or less.

18. The molded part of claim 15, wherein the part is injection molded.

19. The molded part of claim 15, wherein the part is nanomolded.

20. A composite structure comprising a metal component and the molded part of claim 15.
